(19) United States
(12) Patent Application Publication
(10) Pub. No.: US 2011/0074530 A1
(43) Pub. Date: Mar. 31, 2011

(54) MIXED RARE-EARTH PERMANENT MAGNET AND METHOD OF FABRICATION

(75) Inventors: Shengzhi Dong, Shanghai (CN); Kiruba Sivasubramaniam, Clifton Park, NY (US); Chao Yang, Shanghai (CN); Xingmin Liu, Ningbo (CN); Shuai Guo, Ningbo (CN); Bicheng Chen, Ningbo (CN)

(73) Assignee: GENERAL ELECTRIC COMPANY, SCHENECTADY, NY (US)

(21) Appl. No.: 12/570,699

(22) Filed: Sep. 30, 2009

(51) Int. Cl. H01F 7/02; C22C 33/02

(52) U.S. Cl. 335/302; 419/23

(57) ABSTRACT

A permanent magnet comprises boron, cobalt, a metallic alloy component, about 28-35 weight percent of mixed rare-earth material, and iron as a balance. The metallic alloy component is selected from the group consisting of aluminum, copper, niobium, gallium, vanadium, chromium, zirconium, and combinations thereof. The mixed rare-earth material comprises light rare-earth material and heavy rare-earth material. The light rare-earth material comprises at least about 50 weight percent of praseodymium and about 5-50 weight percent of neodymium. The heavy rare-earth material comprises dysprosium or a combination of dysprosium and terbium. The mixed rare-earth material comprises about 3-45 weight percent of heavy rare-earth material. A sum of intrinsic coercivity in the unit of kilo Oersted (kOe) and maximum energy product in unit of mega gauss Oersteds (MGOe) of the permanent magnet is at least about 55.

### BACKGROUND

The invention relates generally to permanent magnets and more particularly to a mixed rare-earth permanent magnet and a method of fabrication.

Rare-earth material based permanent magnets are employed in computers, motors, generators, automobiles, wind turbines, windmills, laboratory equipment, medical equipment, and other equipment and devices. One example of a permanent magnet is a neodymium-ion-boron (Nd—Fe—B) alloy based magnet. In order to obtain a Nd—Fe—B based magnet with a high coercivity, heavy rare-earth elements with high magnetocrystalline anisotropy fields, such as terbium (Tb) and dysprosium (Dy), are added into the alloy. For example, one commercially available magnet material comprises, about 1.5 weight percent (wt %) of Tb and about 3-5 weight percent of Dy in the alloy. Tb is a very expensive element such that about 1.5 wt % of Tb costs more than about 30% of the total raw material of the magnet. Accordingly, it would be desirable to have rare-earth permanent magnets with reduced cost but with compatible magnet properties and a method of producing such rare-earth permanent magnets.

### BRIEF DESCRIPTION

In accordance with an embodiment disclosed herein, a permanent magnetic comprises boron, cobalt, a metallic alloy component, about 28-35 weight percent of mixed rare-earth material, and iron as a balance. The metallic alloy component is selected from the group consisting of aluminum, copper, niobium, gallium, vanadium, chromium, zirconium, and combinations thereof. The mixed rare-earth material comprises light rare-earth material and heavy rare-earth material. The light rare-earth material comprises at least about 50 weight percent of praseodymium and about 5-50 weight percent of neodymium. The heavy rare-earth material comprises dysprosium or a combination of dysprosium and terbium. The mixed rare-earth material comprises about 3-45 weight percent of heavy rare-earth material. A sum of intrinsic coercivity in the unit of kilo Oersted (kOe) and maximum energy product in unit of mega gauss Oersteds (MGOe) of the permanent magnet is at least about 55.

In accordance with another embodiment disclosed herein, a method of producing a permanent magnet comprises melting boron, cobalt, a metallic alloy component (M), a mixed rare earth material, and iron together to form a melted alloy and forming a first alloy ingot using the melted alloy. The permanent magnet comprises about 28-35 weight percent of rare earth material. The first alloy ingot is crushed into particles having a first average particle diameter less than about 3 millimeters. The particles are milled to form a powder mixture with a second average particle diameter in the range from about 2.5-5 microns. The powder mixture is shaped in a magnetic field, into a powder compact. The powder compact is sintered at a temperature ranging from about 1020-1120 degrees centigrade for a time duration ranging from about 1-5 hours to form a second ingot. A second ingot is subjected to an aging process at a temperature ranging from about 450-650 degrees centigrade for time duration ranging from about 1-5 hours.

### DETAILED DESCRIPTION

Embodiments of the invention relate to a mixed rare-earth permanent magnet comprising less terbium (Tb) or even no Tb while having a high coercivity, a high maximum energy product (BHₘₐₓ), and/or a high remanence. Embodiments of the invention also include a method of producing a mixed rare-earth permanent magnet.

Approximating language, as used herein throughout the specification and claims, may be applied to modify any quantitative representation that could permissibly vary without resulting in a change in the basic function to which it is related. Accordingly, a value modified by a term or terms, such as “about,” is not to be limited to the precise value specified. Additionally, when using an expression of “about a first value−a second value,” the about is intended to modify both values. In some instances, the approximating language may correspond to the precision of an instrument for measuring the value or values.

Unless defined otherwise, technical and scientific terms used herein have the same meaning as is commonly understood by one of skill in the art to which this invention belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items.

As used herein, “coercivity” is a property of the permanent magnet that represents the amount of demagnetizing force needed to reduce the induction of the permanent magnet to zero after the magnet has previously been brought to saturation. Typically, the larger the coercivity or coercive force (Hc), the greater the stability of the magnet in a high-temperature environment and the less the magnet is affected by an external magnetic field. “Intrinsic coercivity” or intrinsic coercive force (Hcj) of the magnet is the magnetic material's inherent ability to resist demagnetization corresponding to a zero value of intrinsic induction (J).

As used herein, “maximum energy product (BHₘₐₓ)” is another property of the permanent magnet that refers to a product of the flux density (B) and a magnetic field strength (H) in the permanent magnet. A higher maximum energy product (BHₘₐₓ) represents that the permanent magnet has a higher density of magnetic energy.

As used herein, “remanence” (Br) refers the magnetization left behind in a medium after an external magnetic field is removed. A higher remanence represents that the permancent magnet material has a higher resistance to becoming demagnetized.

As used herein, “rare earth material” refers to a collection of seventeen chemical elements in the periodic table, including scandium, yttrium, the fifteen lanthanoids, and any combination thereof. The fifteen lanthanoids include lanthanum, cerium, praseodymium, neodymium, promethium, samarium, europium, gadolinium, terbium, dysprosium, holmium, erbium, thulium, ytterbium, lutetium. As used herein, “light rare earth material” comprises scandium, yttrium, lanthanum, cerium, praseodymium, neodymium, promethium, samarium, europium, or any combination thereof. As used herein, “heavy rare earth material” comprises gadolinium, terbium, dysprosium, holmium, erbium, thulium, ytterbium, lutetium or any combination thereof.

In certain embodiments of the invention, a mixed rare-earth permanent magnet comprises boron (B), cobalt (Co), a metallic alloy component (M), a mixed rare-earth material (RE), and iron (Fe) as a balance, wherein the metallic alloy component is selected from the group consisting of aluminum (Al), copper (Cu), niobium (Nb), gallium (Ga), vanadium (V), chromium (Cr), zirconium (Zr), or any combination thereof; wherein the permanent magnet comprises about 28-35 weight percent of the mixed rare earth material. The mixed rare earth material comprises light rare-earth material comprising at least about 50 weight percent of praseodymium and about 5-50 weight percent of neodymium and heavy rare-earth material comprising dysprosium or a combination of dysprosium and terbium, wherein the mixed rare-earth material comprises about 3-45 weight percent of the heavy rare-earth material; and wherein a sum of intrinsic coercivity in the unit of kilo Oersted (kOe) and maximum energy product in unit of mega Gauss Oersteds (MGOe) of the permanent magnet is at least about 55.

In certain embodiments, the permanent magnet comprises about 0.3-3 weight percent (wt %) of the metallic alloy component (M). In certain embodiments, the permanent magnet comprises about 62-69 wt % of iron as a balance.

In certain embodiments, the permanent magnet comprises about 28-35 weight percent of mixed rare earth. In certain embodiments, the light rare-earth material comprises about 55 wt % of praseodymium (Pr), and about 5-45 wt % of neodymium (Nd).

In one embodiment, the heavy rare-earth material comprises at least about 90 wt % of dysprosium (Dy) and less than about 10 wt % of terbium (Tb). In one embodiment, the heavy rare earth material comprises about 100 wt % of dysprosium (Dy). In certain embodiments, the heavy rare-earth material consists essentially of dysprosium or consists essentially of a combination of dysprosium and terbium.

In certain embodiments, the permanent magnet comprises about 0.9-1.2 wt % of boron (B). In certain embodiments, the permanent magnet comprises about 0.1-5 wt % of cobalt (Co). In one embodiment, the permanent magnet comprises about 2 wt % of cobalt (Co).

In certain embodiments, an average grain size of the permanent magnet ranges from about 5-18 microns. As used herein, “average grain size” refers to an average diameter of crystallites in the permanent magnet. In certain embodiments, an oxygen content of the permanent magnet is less than about 2500 Parts Per Million (ppm). In one embodiment, the permanent magnet comprises the phase Pr₂Fe₁₄B.

In certain embodiments, a sum of intrinsic coercivity (Hcj) in the unit of kilo Oersted (kOe) and maximum energy product (BHmax) in the unit of mega gauss Oersteds (MGOe) of the permanent magnet is at least about 55 under a room temperature ranging from about 20-25 degrees centigrade (° C.).

In certain embodiments, a method of producing a permanent magnet comprises melting boron (B), cobalt (Co), the metallic alloy component (M), the mixed rare earth material (RE), and iron (Fe) together to form a melted alloy. The melted alloy is fed into a casting mold at a temperature ranging from about 1-80° C. to form a first alloy ingot.

In certain embodiments, the melted alloy may be obtained by an induction melting. In certain embodiments, the first alloy ingot is an alloy strip obtained by a strip casting process and has an average thickness ranging from about 0.2-0.5 millimeters.

In certain embodiments, the first alloy ingot is crushed into particles having a first average particle diameter less than about 3 millimeters. In one embodiment, the first alloy ingot is decrepitated under a room temperature ranging from about 10° C.-30° C. with a hydrogen pressure ranging from about 0.1-0.8 Mpa, for a time duration of at least 1 hour, and then de-hydrogented in a vacuum environment at a temperature ranging from about 500° C.-700° C. with a pressure ranging from 0-1000 Pa for a time duration of about 1-12 hours.

In certain embodiments, the particles are pulverized into a powder mixture with a second average particle diameter ranging from about 2.5-5 microns. In one embodiment, the particles are pulverized into the powder mixture using a jet milling process.

In certain embodiments, the powder mixture is aligned and shaped into a powder compact in a magnetic field. In one embodiment, the powder mixture is pressed into the powder compact in a magnetic field of about 1.2 Tesla-3.0 Tesla, and then is subject to an isostatic pressing in oil under a pressure of about 100-300 MPa.

In certain embodiments, the powder compact is subject to a sintering process at a temperature ranging from about 1020° C.-1120° C. for a time duration ranging from about 1-5 hours to form a second ingot.

In certain embodiments, the sintered second ingot is subject to an aging process at a temperature ranging from about 450° C.-650° C. for a time duration ranging about 1-5 hours.

The following examples are set forth to provide those of ordinary skill in the art with a detailed description of how the methods claimed herein are evaluated, and are not intended to limit the scope of what the inventors regard as their invention.

A comparison of compositions by weight percent of several permanent magnets is illustrated in Table 1 below, whereas items PA1, PA2 and PA3 are three commercially available permanent magnets. An Inductive Coupled Plasma Atomic Emission Spectrometry (ICP-AES) was used to analyze the composition of items PA1, PA2 and PA3. Items E1 to E8 are thirteen experimental examples of the invention with different compositions and/or different fabrication processes.

TABLE 1
Comparison of compositions by weight percent of permanent magnets

| Item | Nd | Pr | Tb | Dy | RE | Co | Ga | Cu | Al | Zr | B | Fe |
|---|---|---|---|---|---|---|---|---|---|---|---|---|
| PA 1 | 24.93 | <0.05 | 1.79 | 1.41 | 28.13 | <0.05 | 0.1 | <0.05 | 0.29 | <0.05 | 0.99 | balance |
| PA 2 | 19.92 | 4.79 | 1.32 | 3.08 | 29.11 | 0.99 | 0.2 | 0.1 | 0.31 | <0.05 | 1.04 | balance |
| PA 3 | 25.31 | <0.05 | 1.26 | 2.44 | 29.01 | <0.05 | 0.09 | <0.05 | 0.41 | <0.05 | 1.03 | balance |
| E 1 | 10 | 16 | 0.5 | 4.5 | 31 | 2 | 0 | 0.2 | 0.3 | 0 | 1 | balance |
| E 2-1 | 10 | 16 | 0.5 | 3.5 | 30 | 2 | 0 | 0.2 | 0.3 | 0 | 1 | balance |
| E 2-2 | 10 | 16 | 0.5 | 3.5 | 30 | 2 | 0 | 0.2 | 0.3 | 0 | 1 | balance |
| E 3-1 | 12 | 14 | 0.5 | 3.8 | 30.3 | 2 | 0 | 0.2 | 0.3 | 0 | 1 | balance |
| E 3-2 | 12 | 14 | 0.5 | 3.8 | 30.3 | 2 | 0 | 0.2 | 0.3 | 0 | 1 | balance |
| E 4-1 | 11.28 | 15.27 | 0 | 3.75 | 30.3 | 2 | 0 | 0.2 | 0.4 | 0 | 1.03 | balance |
| E 4-2 | 11.28 | 15.27 | 0 | 3.75 | 30.3 | 2 | 0 | 0.2 | 0.4 | 0 | 1.03 | balance |
| E 5-1 | 11.28 | 15.27 | 0 | 2.75 | 30.3 | 2 | 0 | 0.2 | 0.4 | 0 | 1.03 | balance |
| E 5-2 | 11.28 | 15.27 | 0 | 2.75 | 30.3 | 2 | 0 | 0.2 | 0.4 | 0 | 1.03 | balance |
| E 6-1 | 9.47 | 17.58 | 0 | 3.25 | 30.3 | 2 | 0 | 0.2 | 0.4 | 0 | 1.03 | balance |
| E 6-2 | 9.47 | 17.58 | 0 | 3.25 | 30.3 | 2 | 0 | 0.2 | 0.4 | 0 | 1.03 | balance |
| E 7 | 11.54 | 16.26 | 0 | 2.5 | 30.3 | 2 | 0 | 0.2 | 0.4 | 0.2 | 1.03 | balance |
| E 8 | 11.54 | 16.26 | 0 | 2.5 | 30.3 | 2 | 0.15 | 0.2 | 0.4 | 0 | 1.03 | balance |

Table 2 is a comparison of properties of the permanent magnets of Table 1, measured under a room temperature of 25° C.

TABLE 2
Comparison of properties of the permanent magnets in Table 1

| | | | BHₘₐₓ | | grain size |
|---|---|---|---|---|---|
| Item | Br (kGs) | Hcj (kOe) | (MGOe) | Hcj + BHₘₐₓ | (μm) |
| PA 1 | 12.84 | 21.25 | 40.15 | 61.4 | 6.9 |
| PA 2 | 13.05 | 20.27 | 41.12 | 61.39 | 9.8 |
| PA 3 | 12.77 | 18.03 | 39.6 | 57.63 | 7.8 |
| E 1 | 12.13 | 24.84 | 35.03 | 59.87 | 8.9 |
| E 2-1 | 12.87 | 17.92 | 38.7 | 56.62 | 11.3 |
| E 2-2 | 12.24 | 22.37 | 36.25 | 58.62 | 7.9 |
| E 3-1 | 12.56 | 23.60 | 38.10 | 61.7 | 9.6 |
| E 3-2 | 12.65 | 23.92 | 38.70 | 62.62 | 9.3 |
| E 4-1 | 12.57 | 20.42 | 38.62 | 59.04 | 15.2 |
| E 4-2 | 12.63 | 19.98 | 39.32 | 59.3 | 13.9 |
| E 5-1 | 12.66 | 20.69 | 39.06 | 59.75 | 10.5 |
| E 5-2 | 12.61 | 20.01 | 39.21 | 59.22 | 9.8 |
| E 6-1 | 12.96 | 17.73 | 39.56 | 57.29 | 8.9 |
| E 6-2 | 12.97 | 17 | 40.14 | 57.14 | 9.5 |
| E 7 | 12.73 | 20.95 | 39.83 | 60.78 | 7.5 |
| E 8 | 13.15 | 19.36 | 41.25 | 60.61 | 6.8 |

As can be seen in Table 1, E1 to E 6-2 have either no terbium or about less than one half the amount of terbium with respect to the commercially available permanent magnets as well as a lower content of neodymium (Nd) and a higher content of praseodymium. Accordingly, E1 to E8 of the invention have a much reduced cost as compared with PA1, PA2 and PA3 yet also have compatible magnetic properties (compared in Table 2).

Further, the use of different aging processes of E 3-1 and E 3-2, E 4-1 and E 4-2, E 5-1 and E 5-2, E 6-1 and E 6-2 show that the examples are repeatable and one-step aging for embodiments of the permanent magnet material is effective to obtain comparable magnetic properties in comparison with two-steps aging processes.

### Exemplary Methods of Producing a Permanent Magnet

For each of the examples, alloys respectively with nominal compositions as in Table 1 were prepared, melted by induction melting, and strip cast to be formed into alloy strips. The strips were decrepitated into particles under a room temperature with a hydrogen pressure of about 0.2 Mpa for about 2 hours and then dehydrogenated in a vacuum environment of about 5 Pa at about 580° C. The particles were subjected to jet-milling to result in fine powders with average diameters ranging from about 3.0-5.0 microns. The fine powders were aligned and pressed into compact in a magnetic field of about 2.0 Tesla. The compact was then pressed isostatically in oil under a pressure of about 200 MPa. The green compacts were subject to a sintering process and an aging step. As is illustrated in Table 3 below, examples E 1 to E 8 were prepared with different sintering process and aging process.

TABLE 3
Comparison of sintering and aging process

| | |
|---|---|
| Sintering process | Aging process |

| | Temperature | Time | Temperature | Time |
|---|---|---|---|---|
| Item | (° C.) | (hours) | (° C.) | (hours) |
| E 1 | 1080 | 2 | 900 + 500 | 2 + 2 |
| E 2-1 | 1060 | 2 | 900 + 500 | 2 + 2 |
| E 2-2 | 1060 | 2 | 900 + 500 | 2 + 2 |
| E 3-1 | 1070 | 2 | 900 + 500 | 2 + 2 |
| E 3-2 | 1070 | 2 | 500 | 2 |
| E 4-1 | 1090 | 2 | 900 + 500 | 2 + 2 |
| E 4-2 | 1090 | 2 | 500 | 2 |
| E 5-1 | 1060 | 2 | 900 + 500 | 2 + 2 |
| E 5-2 | 1060 | 2 | 500 | 2 |
| E 6-1 | 1060 | 2 | 900 + 475 | 2 + 2 |
| E 6-2 | 1060 | 2 | 475 | 2 |
| E 7 | 1070 | 2 | 900 + 500 | 2 + 2 |
| E 8 | 1070 | 2 | 900 + 500 | 2 + 2 |

As is illustrated in Table 3, Examples E1 to E 8 were each subjected to a sintering process at about 1080° C., about 1070° C., about 1090° C. or about 1060° C. for about 2 hours, and quenched to a temperature less than 300° C. to form an ingot. The ingots were then each subject to different aging processes. As is illustrated, E1, E2-1, E2-2, E3-1, E4-1, E5-1, E6-1, E7, E8 were each subjected to at two step aging process, i.e. the sintered ingots were first subject a first aging step at about 900° C. for about 2 hours, quenched to room temperature, and then subjected to a second aging step at about 500° C. or about 475° C. for about 2 hours, which is a conventional aging process for producing permanent magnets. While E3-2, E4-2, E5-2 and E6-2 were each subject to only one step aging process, i.e. the sintered ingots were each subjected to an aging step at about 500° C. or about 475° C. for two hours. As is compared in Tables 1 and 2, E 3-2, E 4-2, E 5-2 and E 6-2 respectively have the same composition and have compatible magnetic properties as compared with E3-1, E4-1, E5-1 and E6-1. The one step aging process is advantageous with respect to cost and manufacturing cycle time reductions.

E 2-1 and E 2-2 were prepared with the same composition, and average particle diameters of the power mixture for preparing the two examples after the pulverizing process were different, which result in different magnetic properties of examples E 2-1 and E 2-2. An average particle diameter of the power mixture after the pulverizing process for E 2-1 was about 3.8 microns, and an average particle diameter of the power mixture after the pulverizing process for E 2-2 was about 3.3 microns. As is compared in Table 2, E 2-2 prepared from the power mixture having a smaller average particle has a higher intrinsic coercivity and a lower remanence.

E7 and E8 are examples respectively comprising zirconium and gallium, which were effective to reduce the average grain sizes and to improve the intrinsic coercivity even when less Dy was used.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. The various features described, as well as other known equivalents for each feature, can be mixed and matched by one of ordinary skill in this art to construct additional systems and techniques in accordance with principles of this disclosure.

1. A permanent magnet comprising:
boron;
cobalt;
a metallic alloy component selected from the group consisting of aluminum, copper, niobium, gallium, vanadium, chromium, zirconium, and combinations thereof;
about 28-35 weight percent of mixed rare-earth material comprising:
light rare-earth material comprising at least about 50 weight percent of praseodymium and about 5-50 weight percent of neodymium; and
heavy rare-earth material comprising dysprosium or a combination of dysprosium and terbium,
wherein the mixed rare-earth material comprises about 3-45 weight percent of heavy rare-earth material; and
iron as a balance,
wherein a sum of intrinsic coercivity in the unit of kilo Oersted (kOe) and maximum energy product in unit of mega gauss Oersteds (MGOe) of the permanent magnet is at least about 55.

2. The permanent magnet of claim 1, wherein the permanent magnet comprises about 0.9-1.2 weight percent of boron.

3. The permanent magnet of claim 1, wherein the permanent magnet comprises about 0.1-5 weight percent of cobalt.

4. The permanent magnet of claim 1, wherein the permanent magnet comprises about 0.3-3 weight percent of metallic alloy.

5. The permanent magnet of claim 4, wherein the metallic alloy component comprises a combination of copper and aluminum.

6. The permanent magnet of claim 1, wherein the heavy rare-earth material comprises a combination of dysprosium and terbium, and wherein the permanent magnet comprises about 3 weight percent of terbium.

7. The permanent magnet of claim 1, wherein an average grain size of the permanent magnet ranges from about 5-18 microns.

8. The permanent magnet of claim 1, wherein an atomic oxygen content of the permanent magnet is less than about 2500 ppm.

9. A method of producing a permanent magnet comprising:
melting boron, cobalt, a metallic alloy component (M), a mixed rare earth material, and iron together to form a melted alloy and forming a first alloy ingot using the melted alloy, wherein the permanent magnet comprises about 28-35 weight percent of rare earth material;
crushing the first alloy ingot into particles having a first average particle diameter less than about 3 millimeters;
milling the particles to form a powder mixture with a second average particle diameter in the range from about 2.5-5 microns;
shaping the powder mixture, in a magnetic field, into a powder compact;
sintering the powder compact at a temperature ranging from about 1020-1120 degrees centigrade for a time duration ranging from about 1-5 hours to form a second ingot; and
aging the second ingot at a temperature ranging from about 450-650 degrees centigrade for time duration ranging from about 1-5 hours.

10. The method of claim 9 further comprising pressing the powder compact iso statically in oil under a pressure of about 100-300 MPa.

11. The method of claim 9, wherein the metallic alloy component is selected from a group consisting of aluminum, copper, niobium, gallium, vanadium, chromium, zirconium, or any combination thereof.

12. The method of claim 9, wherein the mixed rare earth material comprises light rare-earth material and heavy rare-earth material, and wherein the light rare-earth material comprises at least about 50 weight percent of praseodymium and about 5-50 weight percent of neodymium.

13. The method claim 12, wherein the mixed rare-earth material comprises about 3-45 weight percent of heavy rare-earth material, and wherein the heavy rear-earth material comprises dysprosium or a combination of dysprosium and terbium.

14. The method of claim 13, wherein the heavy rare-earth material comprises a combination of dysprosium and terbium, and wherein the permanent magnet comprises about 3 weight percent of terbium.

15. The method of claim 9, wherein crushing comprises decrepitating the first alloy ingot under a room temperature with a hydrogen pressure ranging from about 0.1-0.8 Mpa for a time duration of at least 1 hour, and then de-hydrogenating in a vacuum environment at a temperature ranging from about 500-700 degrees centigrade with a pressure ranging from about 0-1000 Pa for a time duration of about 1-12 hours.

16. The method of claim 9, wherein shaping comprises pressing the powder mixture into a powder compact in a magnetic field of about 1.2-3.0 Tesla.

17. The method of claim 16 further comprising isostatically pressing the powder compact in oil under a pressure of about 100-300 MPa.

18. The method of claim 9, wherein an average grain size of the permanent magnet ranges from about 5-18 microns.
